(19) United States
(12) Patent Application Publication
(10) Pub. No.: US 2016/0140482 A1
(43) Pub. Date: May 19, 2016

(54) Critical Path Scheduling with Drag and Pull

(71) Applicant: Bernard Alan Ertl, Houston, TX (US)

(72) Inventor: Bernard Alan Ertl, Houston, TX (US)

(21) Appl. No.: 14/540,790

(22) Filed: Nov. 13, 2014

(51) Int. Cl. G06Q 10/06

(52) U.S. Cl. CPC G06Q 10/063118

(57) ABSTRACT

Systems, computer-implemented methods and non-transitory computer-readable storage medium are provided for calculating drag and pull metrics in a multi-calendar schedule. A driving relationship is a relationship that determines the start date of its successor (task). Driving relationships are identified during schedule calculation. Driving successor paths, consisting of a path of tasks and relationships where each relationship is a driving relationship, are identified. Post schedule calculation, drag and pull are calculated for any driving paths in the schedule by iteratively recalculating the schedule (forward pass—early start, early finish) while incrementing the duration of each task on the driving path (one task at a time) one time unit per iteration (starting from zero and working up to the task's original duration) and measuring the effect on the end (early finish of the last task) of its successor driving path.

### BACKGROUND

Effective project management requires the development of a realistic plan and a clear communication of the plan from the beginning to the end of the project. The critical path method of scheduling (or “CPM”) is the fundamental tool used to develop and communicate project plans. CPM scheduling calculations can be applied in any project that has a number of individual and interdependent tasks.

In order to use the CPM, a model of the project is constructed. The model includes but is not limited to a list of all activities or tasks required to complete the project, the duration or time to complete each task and the dependencies between the tasks. The CPM may involve graphically depicting or diagramming how a task is related to one or more other tasks. A critical path is defined as a sequence of activities that add up to the longest overall duration. It is the shortest time possible to complete the project. Any delay of a task on the critical path directly impacts the planned project completion date. CPM calculations involve the use of data such as the number of project resources, duration, predecessor and successor relationships, etc. as input variables to: determine the earliest and latest possible dates that each task can start and finish without impacting the duration of the project (also known as early start (ES), early finish (EF), late start (LS), late finish (LF)); determine the longest path of planned tasks to the end of the project; determine “critical” tasks on the longest path, prioritize tasks for effective management; determine the “float” (that is, the amount of time that a task can be delayed without causing a delay to subsequent tasks and the project completion date); and to shorten the planned critical path of a project. Shortening the planned critical path of a project may involve pruning critical path activities, performing more tasks in parallel, or shortening the durations of critical path tasks by adding resources (or utilizing a different method, equipment or tools to accomplish the work).

### SUMMARY

Systems, computer-implemented methods and non-transitory computer-readable storage medium are provided for determining the drag and pull of all tasks in a schedule by identifying all driving relationships in a CPM schedule and calculating drag and pull metrics for any (or all) driving successor path(s) in the schedule.

According to an embodiment, a computer-implemented method for determining a schedule, under control of one more processors configured with executable instructions executing, includes determining a driving successor path in the schedule. The driving successor path involves a path comprising at least one task. The method further includes determining, upon the condition that the path comprises more than one tasks, at least one driving relationship connecting each task to its successor in the path. The driving relationship determines an early start and/or an early finish of a successor task. The schedule comprises a plurality of tasks and one or more relationships. The method further includes the step of calculating the schedule. The identified driving relationship can be marked. Although the term “a driving relationship” and “a driving successor path” are used, it is understood that the same process can be employed for schedules having more than one driving relationships and more than one driving successor paths.

The method further involves automatically determining a drag and/or a pull metric for the driving successor path. Determining the drag and/or the pull metric involves recalculating the schedule iteratively. The step of recalculating the schedule iteratively involves incrementing a duration of each task on the driving successor path. The incrementing step may be performed one time unit per iteration. The impact of the incrementing step can be measured on an early finish of a last task on the driving successor path.

According to another embodiment, a computer program product for determining a schedule includes a non-transitory computer-readable storage device, having stored thereon program code. The code when executed configures a processor to perform executable operations comprising: determining a driving successor path in the schedule. The driving successor path involves a path comprising at least one task; and determining, upon the condition that the path comprises more than one tasks, at least one driving relationship connecting each task to its successor in the path. The driving relationship determines an early start and/or an early finish of a successor task. The schedule comprises a plurality of tasks and one or more relationships. The program code further configures the processor to calculate the schedule and mark the driving relationship.

The program code further configures the processor to perform executable operations comprising automatically determining a drag and/or a pull metric for the driving successor path in the schedule. Determining the drag and/or the pull metric comprises recalculating the schedule iteratively.

The program code further configures the processor to perform executable operations comprising incrementing a duration of each task on the driving successor path. The incrementing of the duration is performed one time unit per iteration. The program code further configures the processor to measure an impact of the incrementing on an early finish of a last task on the driving successor path.

According to yet another embodiment, a system comprises a memory to store instructions; and a processor, coupled to the memory, wherein the processor is configured to execute instructions for determining a driving successor path in the schedule. The driving successor path involves a path comprising at least one task; and determining, upon the condition that the path comprises more than one tasks, at least one driving relationship connecting each task to its successor in the path. The schedule comprises a plurality of tasks and one or more relationships.

The driving relationship determines an early start and/or an early finish of a successor task. The processor is further configured to execute instructions for calculating the schedule.

The processor is further configured to execute instructions for automatically determining a drag and/or a pull metric for the driving successor path in the schedule. Determining the drag and/or the pull involves recalculating the schedule iteratively.

The processor is further configured to execute instructions for: incrementing a duration of each task on the driving successor path; and measuring an impact of the incrementing on an early finish of a last task on the driving successor path.

The aforementioned advantages of the invention, as well as additional advantages thereof, are more fully described by the detailed description of exemplary embodiments and the accompanying drawings.

### BRIEF DESCRIPTION OF THE DRAWINGS

FIG. 1 is an illustration of a block diagram of a system for determining drag and pull in a project schedule according to one embodiment.

FIG. 2A is a diagrammatic view according to one implementation illustrating the identification of driving relationships and driving successor paths.

FIG. 2B is a diagrammatic view illustrating the drag values of tasks along the critical path.

FIG. 2C is a diagrammatic view according to one implementation illustrating the drag values of tasks along a driving successor path that is not the critical path.

FIG. 3 is a flow diagram illustrating an exemplary method for determining drag and pull in a multi-calendar project schedule according to one embodiment.

FIGS. 4A and 4B are screen displays illustrating exemplary embodiments for a user interface displaying driving relationships, driving successor paths, and drag and pull values according to one embodiment.

### DETAILED DESCRIPTION

In this document, the term “CPM” includes all variations of the CPM including the arrow diagramming method (or “ADM”) and the precedence diagram method (or “PDM”). Both the ADM and PDM are graphical methods of depicting the sequence of tasks in a project. PDM can be represented as a network of arrows and nodes where the nodes represent tasks and the arrows indicate dependencies between the tasks. The diagram can also depict the duration of each task and time lags between the starts and finishes of related tasks. The CPM (and its PDM variation) has been used in almost all industries, including the construction industry.

As used in this document, the term “project” is meant to include an enterprise that involves planning and creation of one or more tasks to achieve a desired goal. Projects can be measured based upon time and/or other factors. As used in this document, the term “task” is meant to include an activity or an individual unit of work that is performed as part of an overall project. As used herein, a task may further encompass any block of time that can be scheduled (or is subject to sequencing/scheduling relationships), including, but not limited to, subdivisions of activities/tasks for individual resources. A task can be a line item in project management software. A task can have multiple resources assigned to it and each resource can maintain its own time estimate and is potentially scheduled individually. As used herein, a “resource” can include people, equipment, facilities, capital, etc. that is required for the completion of a task. As used herein, the term “relationship” includes identification of the sequencing/scheduling between a preceding task and a successor task.

As used herein, the term “driving relationship” means a relationship that determines the early start (or early finish) of its successor task. Driving relationships have zero free float. As used herein, the term “driving successor path” includes a path of tasks and relationships where each relationship is a driving relationship. Tasks on a critical path have zero free float. Therefore, the critical path is always a driving successor path. If a task has no successors, the task itself can be considered to be its full driving successor path.

Drag and pull are metrics of the impact of shortening the duration of a task along a driving successor path. As used herein, the term “drag” includes the amount of time a task can be shortened and still affect or shorten the duration of the driving successor path. Every task can have a drag value for its driving successor path. This is irrespective of whether the task is or is not on the critical path. As used herein, the term “pull” includes a measure of how much time can be gained on the driving successor path if the task were shortened by its full drag value. Drag and pull can be used to facilitate critical decisions in managing projects.

A schedule may have multiple calendars. For example, some tasks may be performed seven days a week, while others may be performed only on weekdays. In a schedule with a single calendar, both drag and pull would be the same. In multi-calendar schedules, however, pull measures calendar based constraint delays.

Currently, project management software applications that feature critical path (and critical chain) scheduling lack the ability to identify driving successor path drag and pull values for all tasks along all driving successor paths, including paths with a total float value close to zero, sometimes called “near critical paths”.

When an oil refinery is in turnaround (i.e., shut down in order to perform maintenance or revamping), millions of dollars in potential profits are lost until the refinery is back up and running. A turnaround schedule is generated before the refinery is shut down. However, damage to key process units in the refinery cannot be adequately assessed until the refinery is shut down. Consequently, task duration estimates in the turnaround schedule are subject to a relatively large amount of variation. Thus, it is necessary for project managers to analyze near critical paths in addition to the critical path as there is uncertainty in which path may ultimately prove to be the “true” critical path until the project is underway and more information becomes available.

Consider a refinery with critical process units A, B, and C, which may all be inspected and revamped in parallel during the turnaround. Process A has an estimated total maintenance time of 3 days, and B and C have a total estimated maintenance time of 2.5 days each. The CPM schedule of the turnaround shows that maintenance of A is the critical path. Paths for maintenance of B and C have total float values of 0.5 days. After shutdown, inspection of B reveals major damage, and its maintenance time estimate increases to 4 days. Now, maintenance of B is the turnaround's critical path. Because of the uncertainty in time estimates, maintenance of B and C are near-critical paths. There is a need for CPM software that can analyze all driving successor paths in a schedule to account for uncertainty in task duration estimates or the true critical path of a schedule.

Current project management software applications also lack the ability to calculate both drag and pull for multi-calendar schedules, even for tasks along the critical path. In general, drag and pull are not equal in multi-calendar schedules.

Now, consider a scenario where task A has a duration of 5 days, task B a duration of 7 days, and task C a duration of one day, where both A and B start on the same day, and with relationships A→C and B→C. B→C is a driving successor path that determines the early start date of C. If A, B, and C are on the same calendar, than B's drag and pull are two days. After reducing the duration of B by two days, A and B finish on the same day, both A→C and B→C are driving successor paths of C, and the early start date of C has been reduced by two days. Reducing the duration of B further has no effect on the early start date of C, which is now determined by the driving successor path A→C.

Now consider what happens if A and C are on a Monday to Sunday calendar, B is on a Monday to Friday calendar, and A and B start on Monday of the first week. A is completed on Friday of the first week. However, B is not completed until Tuesday of the second week. B→C is the driving successor path that determines the early start day of C, which is Wednesday of the second week. After reducing B's duration by two days, both A and B are completed on Friday of the first week, both A→C and B→C are driving successor paths of C, and C's early start is Saturday of the first week. Reducing B's duration further has no effect on the early start date of C, which is now determined by the driving successor path A→C. In this case, B has a drag of two days and a pull of four days.

Now suppose that both A and B start on Thursday of the first week. A is completed on Monday of the second week. B is not completed until Friday of the second week, and C's original early start is Saturday of the second week. Now, B's duration can be reduced by four (4) days and still affect the early start date of C. Afterwards, both A and B are completed on Monday of the second week, and C has an new early start date of Tuesday of the second week. Reducing B's duration does not change C's early start date. In this case, B's drag and pull both are equal to four days.

Finally, consider the previous scenario but with C on a Monday to Friday calendar. C's original early start date becomes Monday of the third week. After B's duration is reduced by four days, C's new start date is Tuesday of the second week. In this final scenario, B's drag is four days but B's pull is six days.

Current critical path scheduling software does not take into account drag and pull for such a scenario where tasks are on different calendars. With current critical path scheduling software, the user of the software, such as a planner/scheduler, is required to manually determine drag and pull in multi-calendar schedules. This is a difficult chore as it involves keeping track of multiple calendars and their overlaps or intersections. This can lead to erroneous results, for example, in computing schedule length, determining task criticality, etc., as the schedule changes. Since this involves manually tracking and updating the schedule at a task-by-task level, this process can become increasingly more complex and challenging as the project grows in scale and involves various interdependent tasks. Unwanted errors may be introduced into the schedule. Also, the user may have limited time for analyzing and updating the schedule. Consequently, there is a need for an invention that can resolve these issues. Accordingly, there is a need for an invention that can solve this real world scheduling problem that current project management software is unable to handle/solve.

In accordance with one or more embodiments, systems, computer-implemented methods and non-transitory computer-readable storage medium(s) are provided for identifying all driving relationships in both single and multi-calendar schedules and determining drag and pull for all tasks in a schedule, and particularly, in a CPM schedule. Accordingly, the embodiments of the present disclosure constitute a significant advancement to present technology which cannot handle the determination of drag and pull across multiple calendars. This can facilitate correct scheduling and management of complex, real world projects.

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

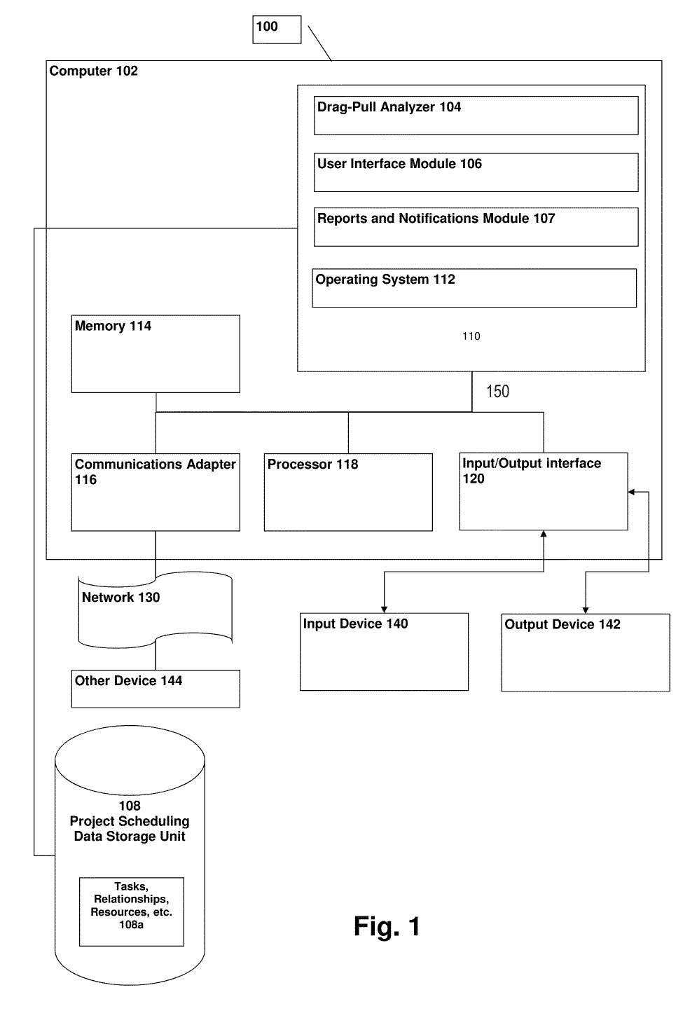

FIG. 1 illustrates a system for analyzing a project schedule 100 according to an embodiment of the present disclosure. The system 100 can include a multitude of interrelated elements. Embodiments of the system 100 can be implemented to some extent as software modules installed and running on one or more data processing systems (‘computer’), such as servers, workstations, tablet computers, PCs, personal digital assistants (‘PDAs’), smart phones, and so on. Computer 102 may include at least one computer processor 118 as well as a computer memory 114. Processor 118 can represent one or more general-purpose processing devices such as a microprocessor, central processing unit, or the like. More particularly, the processor 118 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 118 may also be one or more special-purpose processing devices such as an application specific integrated circuit (ASIC), a field programmable gate array (FPGA), a digital signal processor (DSP), network processor, or the like. The processor 118 can be configured to execute instructions for performing the operations and steps discussed herein. Computer memory 114 may include both volatile random access memory (‘RAM’) and some form or forms of non-volatile computer memory such as a hard disk drive, an optical disk drive, or an electrically erasable programmable read-only memory space (also known as ‘EEPROM’ or ‘Flash’ memory).

The computer memory 114 can be connected through a system bus 150 to the processor 118 and to other system components. Computer 102 may also include one or more input/output network interface device 120. Input/output interface device 120 may implement user-oriented input/output through software drivers and computer hardware for controlling output to output devices 142 such as computer display screens, as well as user input from input devices 140, such as keyboards and mice.

The system 100 may be connected to a project scheduling data storage unit 108. The project scheduling data storage unit 108 can be a local storage unit or a remote storage unit. The project scheduling data storage unit 108 may be a magnetic storage unit, optical storage unit, solid state storage unit or similar storage unit. The project scheduling data storage unit 108 can be a monolithic device or a distributed set of devices. The project scheduling data 108a can be stored in a database, file system or similar data storage system. Project scheduling data 108a may include information or data on the tasks in the project, the relationship(s) between the tasks, the resources required to complete the tasks, the duration of each task, the deadlines associated with the tasks and/or other pertinent data.

The system 100 can also include a computer readable medium 110 on which is stored an appropriate operating system 112. One or more sets of instructions (e.g., software) embodying any one or more of the methodologies or functions described herein may also be stored on the computer-readable storage medium 110. The instructions may also reside, completely or at least partially, within the memory 114 and/or within the processor 118 during execution thereof by the computer 102, the memory 114 and the processor 118 also constituting computer-readable storage media. The instructions may further be transmitted or received over a network 130.

Computer 102 can also include a communications adapter 116 for implementing data communications with other devices 144. Communications adapter 116 implements the hardware level of data communications through which one computer sends data communications to another computer through a network. The computer 102 can be accessible to any number of other devices, user machines and users 144 through a network 130. The other devices 144 can be any type of computing device including desktop computers, laptop computers, handheld computers or similar computing device. The network 130 can be local area network (LAN), such as an intranet within a company, a wide area network (WAN), such as the Internet or similar communication system. The network 130 can include any number of networking and computing devices including any number of wired and wireless devices. The network 130 may include connections, such as wire, wireless communication links, or fiber optic cables.

Any combination of one or more computer readable media 110 may be utilized. The computer readable medium 110 may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Instructions or program code embodied on the computer readable medium 110 may be transmitted using any appropriate medium, including but not limited to wireless, wireline, optical fiber cable, RF, etc., or any suitable combination of the foregoing. Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

In one embodiment, the program code can include instructions for a drag-pull analyzer 104, a user interface module 106, and a reporting and notification module 107 and or a software library containing methods that call such modules. This division of functionality is presented merely by way of example for the sake of clarity. One skilled in the art would understand that the functionality described could be combined into a monolithic component or sub-divided into any similar combination of components. In certain embodiments, the drag-pull analyzer 104, the user interface module 106, and the reports and notification module 107 may be implemented on a separate server.

While the computer-readable storage medium 110 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The drag-pull analyzer 104, the user interface module 106, and the reports and notification module 107 may be implemented as one or more sub-modules operating in separate software layers or in the same layer. Although depicted separately from the operating system 112, these or one or more sub-modules may be incorporated as part of the operating system 112. In some embodiments, the drag-pull analyzer 104 may be implemented in a project server, in the software stack, in hardware, in firmware (such as in the BIOS), or in any other manner as will occur to those of ordinary skill in the art.

The drag-pull analyzer 104 can continually and automatically retrieve and analyze the project scheduling data 108a, in a real time basis, or in a substantially real time basis, to process driving relationships and driving successor paths. The project scheduling data may be analyzed to determine driving relationships and driving successor paths. The drag-pull analyzer 104 can further calculate a drag and pull value for any or all tasks in the schedule. Although the exemplary embodiments herein refer to “a” driving relationship or driving successor path, the embodiments of the invention are applicable and are meant to encompass a plurality of driving relationships and driving successor paths.

The user interface module 106 can interface with any of the other modules or components of the computer 102 including the drag-pull analyzer 104 and the reports and notification module 107 to generate a project scheduling interface to be utilized by a user, such as, a project planner or project manager. The user interface module 106 can provide a graphical user interface or command line interface for remote other devices 144 over the network 130. Any number of other devices 144 may be used to access the user interface module 106. The user interface module 106 can be a web-based interface such as a web server or similar specialized interface to interact with the client on remote machines.

The user interface provided by the user interface module 106 can be accessed by general-purpose browsers or specialized applications. The user interface module 106 interfaces the computer 102 with the other devices 144 by making available the functionality of the drag-pull analyzer 104 and the reports and notification module 107.

The reports and notifications module 107 interfaces with the drag-pull analyzer 104. Reports, alerts and notifications can be generated to inform one of more users of the updated schedule. The reports may be in the form of Gantt charts that display the driving relationships, driving successor paths, drag values, and pull values. These notifications can be displayed in a report upon user request (using the user interface module 106. These notifications can also be in the form of automatic notices that get sent in the form of an email, alert, and/or logged to a database for further review by one or more users.

When calculating the schedule (early start, early finish, late start, late finish), all driving relationships in the schedule are identified (marked). Because driving relationships are relationships that drive (determine) the early start (or early finish) of their successor task, driving relationships have zero free float.

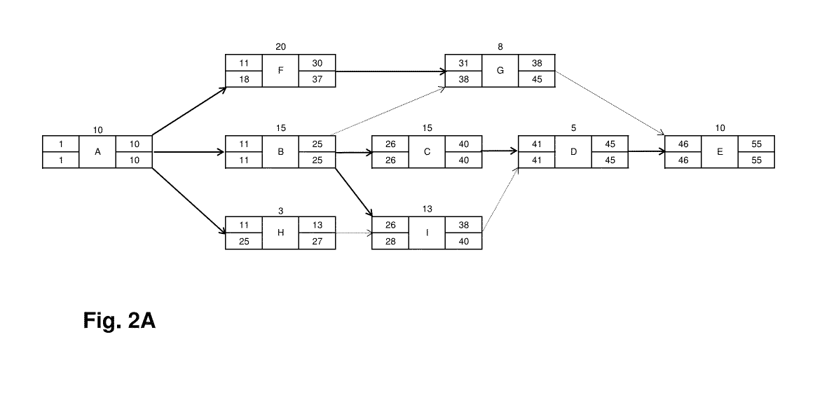

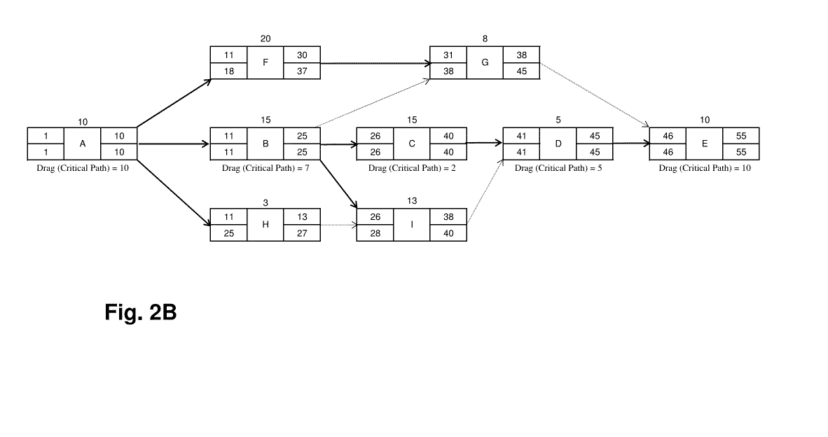

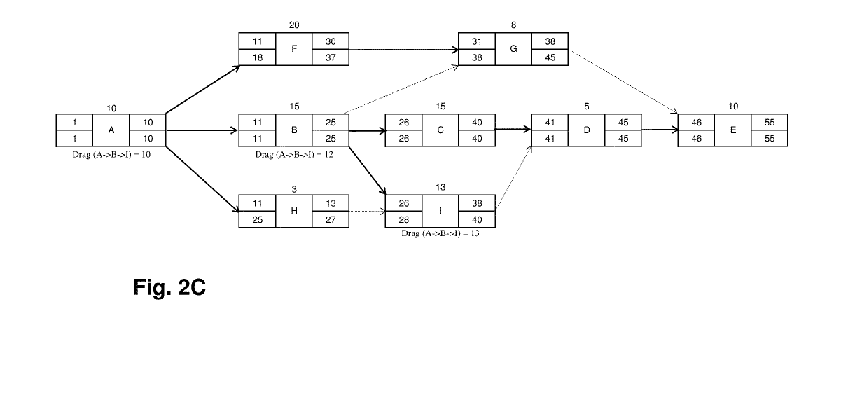

FIG. 2A depicts an example schedule as a network logic diagram. Each box represents a task in the schedule. The duration of each task is shown as a number on top of the task's box. Each task has an early start, early finish, late start, and late finish time, shown in the upper left corner, upper right corner, lower left corner, and lower right corner of the task's box respectively. Relationships are shown as directed arrows going forward in time. Paths in the diagram correspond to a set of tasks connected by relationships. The critical path is the path with the longest duration from the early start of the first task to early finish of the last task in the path.

FIG. 2A represents a diagrammatic view illustrating the identification of driving relationships and driving successor paths, according to an embodiment of the invention. In FIG. 2A, all relationships are shown by arrows, and all driving relationships are represented as solid arrows. The relationship A→H is a driving relationship because there is zero float between A's early finish of 10 and H's early finish of 11. H→I is not a driving relationship, because there is a float of 12 between H's early finish of 13 and I's early start of 26.

A driving successor path consists entirely of tasks and driving relationships. The critical path is always a driving successor path. The critical path of the schedule in FIG. 2A is (A→B→C→D→E), with a total duration of 55 days (that is, 10+15+15+5+10). Every relationship in the critical path (A→B, B→C, C→D, D→E) is a driving relationship. The path A→F→G is also a driving successor path. The path A→F→G→E is not a driving successor path because the relationship G→E does not affect the early start time of task E (i.e., G→E has a non-zero free float value).

The duration of a driving successor path may shorten as the working time of a task in the path is compressed. Drag measures how much time a task can be shortened and still affect/shorten its driving successor path. In the prior art, only drag with respect to the critical path can be calculated. In FIG. 2B, the drag of tasks in the critical path (A→B→C→D→E) is shown as “Drag (Critical Path)=”. Tasks A, D and E have critical path drag values equal to their durations. The durations of tasks A, D, or E can be reduced all the way to zero while still shortening the duration of the critical path (and thus the schedule). However, task C has a drag of 2 days, less than its duration of 21 days. After shortening the duration of task C from 15 to 13 days, A→B→C→D→E remains a critical path with a duration of 53 (=55-2) days, but path A→B→I→D→E is now also critical path with a duration of 53 (=10+15+13+5+10) days. Further shortening the duration of C will not shorten the schedule's duration of 53, because the path A→B→C→D→E will no longer be a critical path, while A→B→I→D→E remains as the only critical path in the schedule. Similarly, task B has a drag of 7 days, less than its duration of 15 days. The duration of B can be reduced by 7 days while still shortening the duration of the critical path. After B's duration is reduced from 15 to 8, the duration of A→B→C→D→E is 48 days and remains a critical path, but path A→F→G→E is now also a critical path with a duration of 48 (=10+20+8+10) days. Further reducing the duration of B shorten the schedule's duration of 53 days, because the path A→B→C→D→E will no longer be a critical path, while A→F→G→E remains as the only critical path in the schedule

The embodiments discussed herein, as discussed earlier, extend the drag metric to all driving successor paths. FIG. 2C depicts the same schedule as in FIGS. 2A and 2B. FIG. 2C shows drag values for tasks in the driving successor path A→B→I, consisting of driving relationships A→B and B→I. A→B→I has a duration of 38 days (=10+15+13). Note that A→H→I (with a duration of 26=10+3+13) is not a driving successor path because H→I is not a driving relationship. After the duration of task B is reduced by 12, from 15 to 3 days, the early start of I has decreased from 26 to 14 days. At this point, A→B→I and A→H→I are now driving successor paths, both with a duration of 26 days. With any further decrease in B's duration, A→B→I is no longer a driving successor path, and I's early start is now determined by the remaining driving successor path A→H→I.

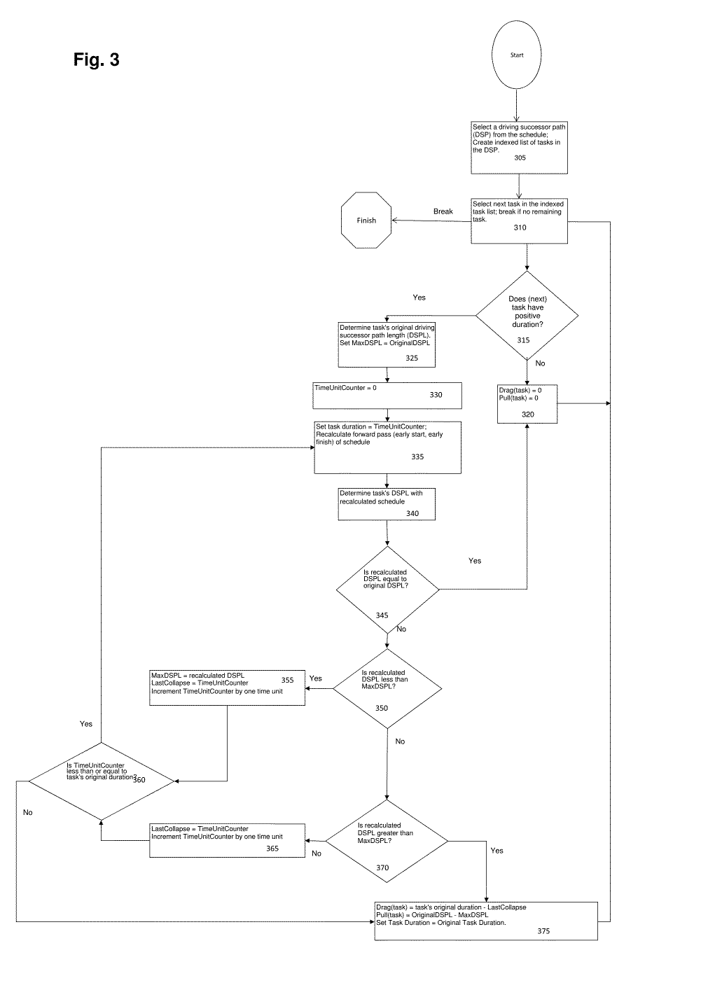

FIG. 3 is a flowchart outlining an example method for automatically determining the drag and pull for all tasks in a driving successor path, in accordance with one illustrative embodiment. Although not shown in FIG. 3, the method can start with a request to analyze a driving successor path (DSP) in the schedule. This request may be generated in response to a user input, or it may be automatically generated in response to a detected change in the status of one or more tasks, relationships or other project data (elements). Irrespective of the origin of the request, in response to receiving this request, tasks from the selected driving successor path may be placed into an indexed list 305. As described with reference to the system in FIG. 1, project scheduling data or information about these tasks may be retrieved from a project scheduling database.

The method further comprises selecting the next task from the indexed list 310. When there are no more tasks in the list, a break occurs and the operation stops. Otherwise, the next step is checking whether the task has a positive duration 315. If not, the drag and pull of the task are set to zero 320, and the next task in the indexed list is selected 310.

If the task has a positive duration (the “Yes” branch of 315), the method further comprises determining the task's original driving successor path length (OriginalDSPL), and initializing variable MaxDSPL to OriginalDSPL 325. OriginalDSPL is calculated in the DSP selected in step 305. The method further comprises initializing TimeUnitCounter to zero 330. All driving successor path lengths are evaluated on a 24/7 (full) calendar regardless of what calendars are used by tasks on the path in question.

The method further comprises recalculating the forward pass (early start, early finish) of the entire schedule with the task's duration set equal to TimeUnitCounter 335. In one embodiment, the assignment Task Duration=TimeUnitCounter is by reference. In another embodiment, TimeUnitCounter is assigned to a temporary variable standing in for the task's duration. In preferred embodiments, the task's duration value in the database is not changed by this assignment. The method further comprises determining the driving successor path length (DSPL) of the selected task in the recalculated schedule 340. As with OriginalDSPL, DSPL is recalculated in the DSP selected in step 305.

The method further comprises checking whether the recalculated DSPL is equal to OriginalDSPL 345. If true, the operation breaks out of the calculation loop and sets drag and pull of the task to zero 320, and the next task in the indexed list is selected 310. The comparison step 345 avoids redundant calculations for a task that has no effect on the schedule.

If the recalculated DSPL is not equal to OriginalDSPL, the method further comprises checking whether the recalculated DSPL is less than the current value of MaxDSPL 350. If comparison 350 is true, MaxDSPL is set equal to the recalculated DSPL, the variable LastCollapse is set equal to the current value of TimeUnitCounter, and TimeUnitCounter is incremented by one time unit 355. LastCollapse tracks the longest task duration where the task's DSPL does not increase as the task's duration is increased from zero. MaxDSPL tracks the smallest DSPL (i.e. the DSPL with the maximum change in value) as the task's duration is increased from zero. LastCollapse is used in the calculation of drag, and MaxDSPL is used in the calculation of pull (see step 375 below). In one embodiment, the user may select a time unit larger than the smallest time unit in the schedule (e.g. incrementing by three hours in an hour-by-hour schedule) to save computation time while still yielding results within an acceptable margin of error.

If the recalculated DSPL is not less than MaxDSPL (i.e. comparison 350 is false) the method further comprises checking whether the recalculated DSPL is greater than MaxDSPL 370. If comparison 370 is false, LastCollapse is set equal to TimeUnitCounter and TimeUnitCounter is incremented by one time unit 365. (When both comparisons 350 and 370 are false, the recalculated DSPL is equal to MaxDSPL (i.e. there is no effect on the task's DSP from increasing its duration one time unit) and there is no need to set MaxDSPL equal to recalculated DSPL in step 365).

If the recalculated DSPL is either less than MaxDSPL (step 350 branch “Yes”) or equal to MaxDSPL (step 370 branch “No”), TimeUnitCounter is incremented by one time unit (step 355 or step 365). The incremented TimeUnitCounter is compared to the task's original duration 360. If TimeUnitCounter is less than or equal to the task's original duration, the method loops back to step 335 for another iteration. Otherwise, drag and pull are calculated, and the task's duration is set back to its original value 375.

If the recalculated DSPL is greater than MaxDSPL (step 350 “No” branch, step 370 “Yes” branch), the method further comprised calculation of pull and drag values 375. Drag is set equal to the task's original duration minus the value of LastCollapse. For example, a task with an original duration of 10 and a LastCollapse of 2 has a drag of 8. For this task, its DSPL did not increase as its duration was increased from zero to two, but its DSPL did increase as its duration was increased from two to three. The amount of time that the duration of this task can be reduced, and still affect its DSPL, is 8, when the task has a duration of 2. Any further reduction in the task's duration does not affect/shorten its DSPL. Pull is set equal to OriginalDSPL minus MaxDPSL. For example, a task with an original DSPL of 12 and a MaxDSPL of 2 has a pull of 10. This is the largest amount of time that can be gained in the DSP by shortening the task's duration. After the calculation of drag and pull, the task's duration is reset to its original value. In one embodiment, task duration is assigned by reference to the location of the original task's duration in the database. In another embodiment, the assignment is by value to a temporary variable holding the task's original duration. After this step, the method further comprises selection of the next task for evaluation from the indexed list 310.

The term “algorithm” can encompass an algorithm or a rule set. It may be possible to implement one or more embodiments of the invention as distributed/event driven process. For example, it may be possible to implement one or more embodiments of the invention using stored procedures or triggers in a database as opposed to a dedicated computational process.

To demonstrate this method, consider the example discussed earlier, where task A has a duration of 5 days, task B a duration of 7 days, and task C a duration of one day, with relationships A→C and B→C. A and C are on a Monday to Sunday calendar, B is on a Monday to Friday calendar. A and B start on Monday of the first week. A is completed on Friday of the first week. B is not completed until Tuesday of the second week. B→C is the driving successor path that determines the early start day of C, which is Wednesday of the second week.

The algorithm disclosed in FIG. 3 can be used to determine the drag of B. Recall that DSPL is measured in a 24/7 calendar. OriginalDSPL of B→C is 10, which is the sum of the durations of B, C, and the weekend of the first week (7+1+2=10). On the first pass of step 335, when the duration of B is set to zero, the recalculated DPSL of B→C is equal to six, because C now starts on Saturday of the first week as determined by the path A→C in the recalculated schedule, and the algorithm sets MaxDSPL=6. As the duration of B is incremented to five, the recalculated DPSL of B→C remains equal to six, as C's start is still determined by A→C. At this point, after step 365, LastCollapse=5 and MaxDPSL=6. After the duration of B is incremented to six, the recalculated DSPL of B→C is equal to nine, because C now starts on the Tuesday of the second week as determined by the path B→C in the recalculated schedule. At this point, the algorithm in FIG. 3 takes the “Yes” branch of step 370 and calculates the drag and pull of B. The drag of B equals 2, which is its original duration (=7-5) minus LastCollapse. The pull of B equals 4, which is OriginalDSPL minus MaxDPSL (=10-6).

Now consider the same situation above but where A and B start on Thursday of the first week. A is completed on Monday of the second week. B is completed on Friday of the second week, and C starts and finishes on Saturday of the second week. OriginalDSPL of B→C is equal to 10. When the duration of B is set to zero, the recalculated DSPL of B→C is equal to six, because C starts on Tuesday of the second week in the recalculated schedule. The algorithm sets MaxDSPL=6 on the initial pass of step 335. As the duration of B is increased to three, the recalculated DPSL of B→C remains equal to six, because C still starts on Tuesday in the recalculated schedule. At this point, LastCollapse=3 and MaxDPSL=6. When the duration of B is incremented to four, the recalculated DSPL of B→C becomes equal to seven, because C now starts on the Wednesday of the second week as determined by the path B→C in the recalculated schedule. At this point, the algorithm in FIG. 3 takes the “Yes” branch of step 370 and calculates the drag and pull of B. The drag of B is equal to 4, which is its original duration (=7-3). The pull of B is equal to 4, which is OriginalDSPL minus MaxDPSL (=10-6).

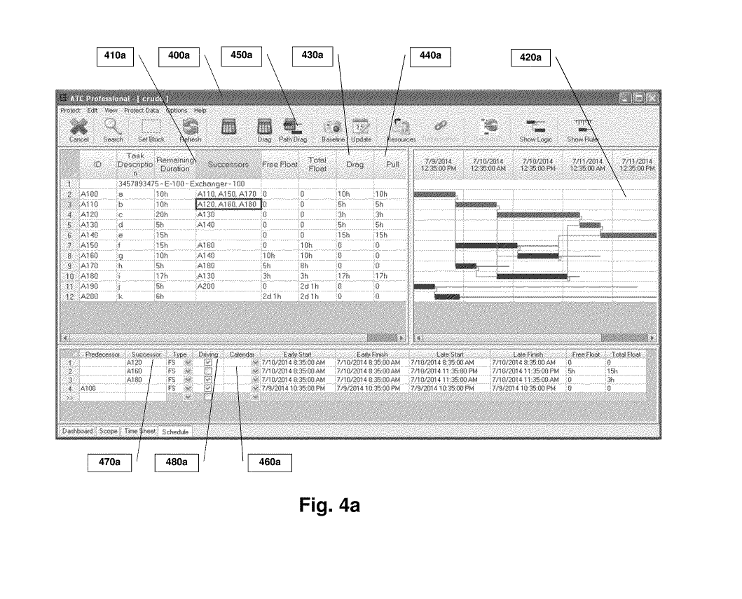

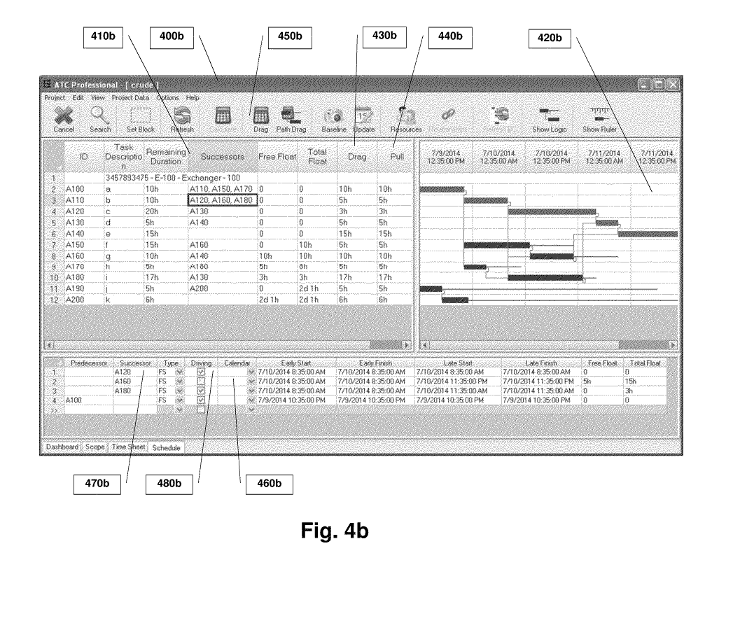

FIGS. 4A and 4B depict exemplary screen displays 400a, 400b. The user can define various tasks in an editing grid 410a, 410b shown in the top left pane. In these examples, Record/line 1 can include a summary or header. Records/lines 2-12 can include tasks with generic descriptions, shown here using identifiers a, b, c, d, e etc. Each task can be assigned a unique identifier (“ID”). Each task is further associated with a specific duration. Furthermore, each of the tasks may be associated with predecessor and/or successor tasks (for example, a list of unique identifiers for each task). A graphic representation of the schedule can be displayed in the top right pane 420a, 420b. For example, a Gantt chart format can be used to display the schedule.

As shown in FIG. 4A, a task can be selected by selecting its record/line in the editing grid 410a. When the user selects the Path Drag toolbar button 450a, the drag and pull for all tasks related to the selected task are displayed in the Drag column 430a and Pull column 440a respectively. As shown in the bottom pane 460a, the successors of the selected task are displayed in column 470a. Column 480a indicates which successors have a driving relationship with the task selected in the editing pane 410a.

As shown in FIG. 4b, when the user selects the Drag toolbar button 450b, the drag and pull for all tasks are displayed in the Drag column 430b and Pull column 440b respectively. The user can select a task by selecting its record/line in the editing grid 410b. As shown in the bottom pane 460b, the successors of the selected task are displayed in column 470b. Column 480b indicates which successors have a driving relationship with the task selected in the editing pane 410b.

In the embodiment displayed in FIGS. 4a, 4b, the drag value displayed is the minimum drag value for the selected task over all of its driving successor paths, and the pull is the corresponding pull for the driving successor path with the minimum drag. In another embodiment, the drag displayed may correspond to the task's longest driving successor path. In another embodiment, the drag displayed may correspond to the driving successor path with the smallest total float (i.e., the most critical driving successor path). In another embodiment, the drag may correspond to a specific driving successor path either chosen by an end user or by some other method. In another embodiment, not shown in FIGS. 4a, 4b, the drag and pull of the selected task may be displayed for each driving relationship in the bottom pane.

Advantageously, a unique coding or coloring schema can be used to identify driving successor path relationships (for example, in a white background).

Unless specifically stated otherwise as apparent from the above discussion, it is appreciated that throughout the description, discussions utilizing terms such as “determining,” “assigning,” “associating,” “analyzing,” “displaying,” “presenting,” or the like, refer to the actions and processes of a computer system, or similar electronic computing device that manipulates and transforms data represented as physical (electronic) quantities within the computer system's registers and memories into other data similarly represented as physical quantities within the computer system memories, registers or other such information storage, transmission or display devices.

No limitation with regard to the described aspects or embodiments of the present invention is intended. Many modifications to the depicted embodiments may be made without departing from the spirit and scope of the present invention. For example, it may be possible to only consider the primacy relationship during the calculation of the forward pass while ignoring the primacy relationship and using a different heuristic for determining the backward pass. Accordingly, the foregoing description is intended to be illustrative rather than restrictive. The invention described herein is defined by the appended claims and all changes to the invention that fall within the meaning and the range of equivalency of the claims are embraced within their scope.

While the system, computer readable storage medium and methods are described in terms of “comprising,” “containing,” or “including” various components or steps, the system, computer readable storage medium and methods also can “consist essentially of” or “consist of” the various components and steps. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A computer-implemented method for determining a schedule comprising:
under control of one more processors configured with executable instructions:
determining a driving successor path in the schedule, wherein the driving successor path comprises a path comprising at least one task, and
upon the condition that the path comprises more than one tasks, determining at least one driving relationship connecting each task to its successor in the path,
wherein the schedule comprises a plurality of tasks and one or more relationships, and
wherein the driving relationship determines an early start and/or an early finish of a successor task.

2. The method according to claim 1, further comprising calculating the schedule.

3. The method according to claim 1, further comprising marking the determined driving relationship.

4. The method according to claim 1, further comprising automatically determining a drag and/or a pull metric for the driving successor path.

5. The method according to claim 4, wherein determining the drag and/or the pull metric comprises recalculating the schedule iteratively.

6. The method according claim 5, further comprising incrementing a duration of each task on the driving successor path.

7. The method according to claim 6, wherein the incrementing is performed one time unit per iteration.

8. The method according to claim 6, further comprising measuring an impact of the incrementing on an early finish of a last task on the driving successor path.

9. A computer program product for determining a schedule, the computer program product comprising:
a non-transitory computer-readable storage device, having stored thereon program code that, when executed, configures a processor to perform executable operations comprising:
determining a driving successor path in the schedule, wherein the driving successor path comprises a path comprising at least one task, and
upon the condition that the path comprises more than one tasks, determining at least one driving relationship connecting each task to its successor in the path,
wherein the schedule comprises a plurality of tasks and one or more relationships, and
wherein the driving relationship determines an early start and/or an early finish of a successor task.

10. The computer program product according to claim 9, wherein the program code further configures the processor to perform executable operations comprising calculating the schedule.

11. The computer program product according to claim 9, wherein the program code further configures the processor to perform executable operations comprising automatically determining a drag and/or a pull metric for the driving successor path.

12. The computer program product according to claim 11, wherein determining the drag and/or the pull metric comprises recalculating the schedule iteratively.

13. The computer program product according claim 12, wherein the program code further configures the processor to perform executable operations comprising incrementing a duration of each task on the driving successor path.

14. The computer program product according to claim 13, wherein the incrementing is performed one time unit per iteration.

15. The computer program product according to claim 14, wherein the program code further configures the processor to perform executable operations comprising measuring an impact of the incrementing on an early finish of a last task on the driving successor path.

16. A system comprising:
a memory to store instructions; and
a processor, coupled to the memory, wherein the processor is configured to execute instructions for determining a schedule, comprising:
determining a driving successor path in the schedule, wherein the driving successor path comprises a path comprising at least one task, and
upon the condition that the path comprises more than one tasks, determining at least one driving relationship connecting each task to its successor in the path,
wherein the schedule comprises a plurality of tasks and one or more relationships, and
wherein the driving relationship determines an early start and/or an early finish of a successor task.

17. The system according to claim 16, wherein the processor is further configured to execute instructions for calculating the schedule.

18. The system according to claim 16, wherein the processor is further configured to execute instructions for automatically determining a drag and/or a pull metric for the driving successor path.

19. The system according to claim 18, wherein determining the drag and/or the pull metric comprises recalculating the schedule iteratively.

20. The system according claim 18, wherein the processor is further configured to execute instructions for:
incrementing a duration of each task on the driving successor path; and
measuring an impact of the incrementing on an early finish of a last task on the driving successor path.
